(19) United States
(12) Patent Application Publication
(10) Pub. No.: US 2006/0119553 A1
(43) Pub. Date: Jun. 8, 2006

(54) Display module

(75) Inventor: Isao Akima, Ogaki-shi (JP)

Correspondence Address: SHERIDAN ROSS PC, 1560 BROADWAY, SUITE 1200, DENVER, CO, 80202, US

(73) Assignee: SANYO ELECTRIC CO., LTD.

(21) Appl. No.: 11/285,830

(22) Filed: Nov. 22, 2005

(30) Foreign Application Priority Data
Nov. 25, 2004 (JP) 2004-340178

(51) Int. Cl. G09G 3/30

(52) U.S. Cl. 345/77

(57) ABSTRACT

A display module enabling recognition of an image when the entire screen is bright (or dark). A current drive circuit includes a current amount control circuit for controlling the amount of current supplied from a high potential power supply to a transmission path in response to a current control signal. A drive current generation circuit controls the amount of current flowing through a transmission line in accordance with a gray scale value of video data based on RGB pulse width modulation signals. Current, which corresponds to the difference between the current of the current amount control circuit and the current controlled by the drive current generation circuit, flows through the transmission line. When using the drive current of the drive current generation circuit as a base current, the current amount control circuit adds current to the drive current with the current control signal.

### BACKGROUND OF THE INVENTION

The present invention relates to a display module.

In the prior art, a display panel using liquid crystal or the like performs gray-scale display for displaying halftone images or for displaying color images using the three primary colors of red, green, and blue (RGB) (refer, for example, to Hiroyuki Nitta and Yasuyuki Kudo, “Color LCD System Shokai (Detailed Explanation on Color LCD System)”, Transistor Gijutsu September 2000, CQ Publishing Co., Ltd., Sep. 1, 2000, pp. 255-268). A liquid crystal cell changes its light transmissivity in accordance with the applied voltage. The display panel uses such property of a liquid crystal cell in gray-scale display. In detail, the display panel displays a gray-scale image by changing the voltage amplitudes of data signal in accordance with video data to adjust the voltages applied to the liquid crystal cells. A display module using light emitting elements such as light emitting diodes (LEDs) also displays a gray-scale image in the same manner.

A display module displays an image on a screen with various luminous brightness amounts depending on the environment in which the display module is used. For example, the display image may be bright throughout the entire screen, that is, the image may have a high brightness amount. Alternatively, the display image may be dark throughout the entire screen, that is, the image may have a low brightness amount. Thus, a person would visually perceive the entire screen image differently from the portion displaying an image. This is because a person visually recognizes an image of a screen through brightness. More specifically, when a screen includes a dark cell area formed by cells having a low brightness amount and a bright cell area formed by cells having a high brightness amount, a person would perceive the difference in brightness between cells in the bright (or dark) cell area (distinguish cells having a small difference in brightness amount (difference in gray scale level) from one another). However, when the entire screen is bright (or dark), humans are unable to perceive the difference in brightness between cells in the bright (or dark) area (distinguish cells that have a small difference in gray scale level from one another). Accordingly, when the display image is entirely bright (or dark), individual cells in the image are difficult to recognize.

### SUMMARY OF THE INVENTION

It is an object of the present invention to provide a display module that enables easy recognition of an entirely bright (or dark) image.

One aspect of the present invention is a display module for displaying an image in accordance with video data including brightness and a gray scale value. The display module includes a plurality of current drive elements operated by a drive current. A current drive circuit generates the drive current in accordance with the gray scale value of the video data and the brightness of the video data.

Another aspect of the present invention is a display module for displaying an image in units of single frames in accordance with video data including brightness and a gray scale value. The display module includes a drive current generation circuit for generating drive current in accordance with the gray scale value of the video data. A current adding circuit, connected to the drive current generation circuit, adds current to the drive current in accordance with the brightness of the video data for one frame. A current drive element is operated by the drive current.

A further aspect of the present invention is a display module for displaying an image in units of single frames in accordance with video data including brightness and a gray scale value. The display module includes a transmission path. A current amount control circuit, connected to the transmission path and a high potential power supply, controls the amount of current supplied from the high potential power supply to the transmission path in accordance with the brightness of the video data for one frame. A drive current generation circuit, connected to the transmission path, generates drive current in accordance with the gray scale value of the video data based on the current flowing through the transmission path. A current drive element is operated by the drive current.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing a video data display system according to a preferred embodiment of the present invention;

FIG. 2 is a waveform diagram of signals for variable current control;

FIG. 3 is a waveform diagram of signals for color display; and

FIG. 4 is a schematic block diagram of a display module incorporated in the video data display system of FIG. 1.

### DETAILED DESCRIPTION OF THE PREFERRED EMBODIMENTS

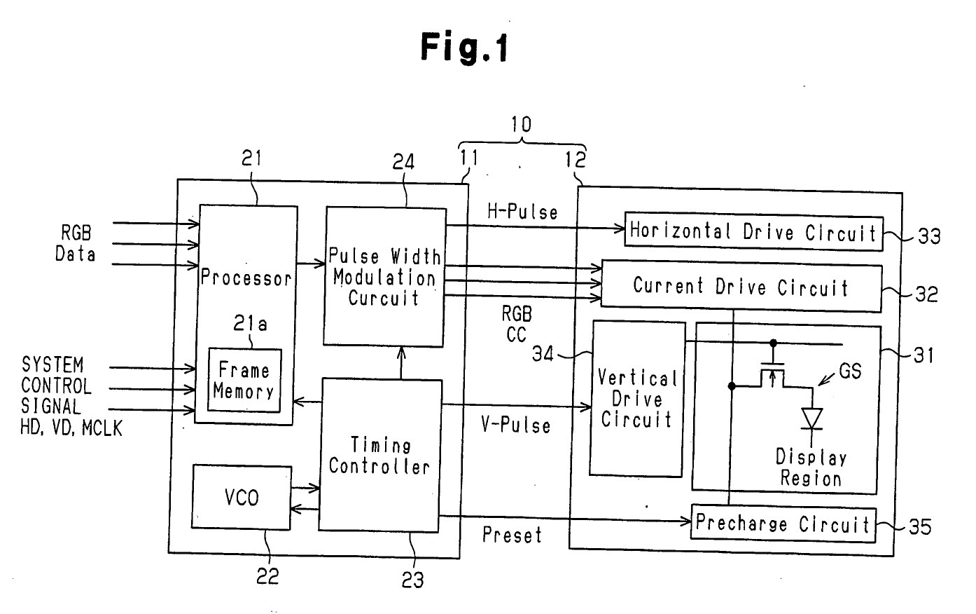

A video data display system 10 according to a preferred embodiment of the present invention will now be described with reference to FIGS. 1 to 4.

As shown in FIG. 1, the video data display system 10 includes a video signal processing unit 11 and a display module 12. The video signal processing unit 11 includes a processor 21, a voltage controlled oscillator (VCO) 22, a timing controller 23, and a pulse width modulation circuit 24.

The processor 21 performs predetermined signal processing on RGB video data, which is provided from an external device (not shown), and stores the signal-processed video data in a frame memory 21a. The processor 21 converts the RGB video data, which is provided from the external device, into video data configured by bits, the number of which corresponds to the number gray scales, and stores the video data in the frame memory 21a in units of frames.

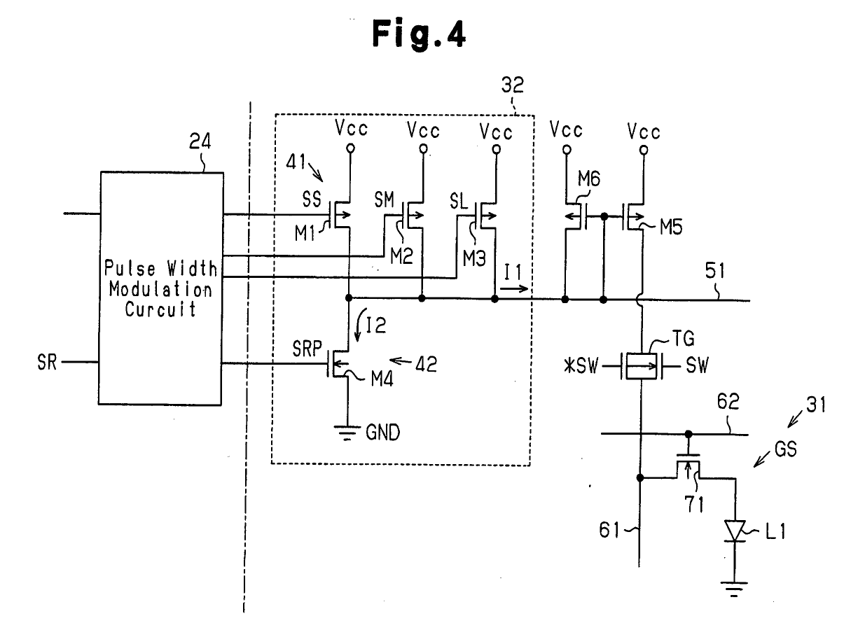

The VCO 22 generates a clock signal for operating the video signal processing unit 11 and the display module 12. The timing controller 23 receives the clock signal from the VCO 22 and generates various timing signals used in the video signal processing unit 11 and various timing signals used in the display module 12. The pulse width modulation circuit 24, which is operated in accordance with the timing signals, generates RGB pulse width modulation signals (signals SRP, SGP, and SBP shown in FIG. 3) based on video data read from the frame memory 21a. Each of the pulse width modulation signals SRP, SGP, and SBP has a pulse width that is in accordance with the gray scale value. The ON and OFF states shown in FIG. 3 indicate the states of a transistor M4 (FIG. 4) that will be described later.

The processor 21 calculates a determination value for a single frame of video data. Then, the processor 21 generates current control data in units of a predetermined number of frames (e.g., one frame) based on the determination value. The determination value indicates brightness tendency of an image corresponding to one frame. The determination value may be set based on an intermediate value of the number of gray scale levels (e.g., 128 for 256 gray scale levels). For example, the determination value is set greater than the intermediate value when the image is entirely bright and set smaller than the intermediate value when the image is entirely dark. The relationship between the determination value and the intermediate value is set assuming that a gray scale value for an all black pixel is 0 and a gray scale value for an all white pixel is 255. The current control data is used to vary the amount of current applied to each cell in the display module 12.

For example, the processor 21 calculates the average of the brightness values in video data corresponding to one frame as a determination value. The processor 21 further calculates a difference D between the calculated average value and the intermediate value of the number of gray scale levels of the display module 12 (128 for 256 gray scale levels). The processor 21 compares the calculated difference value D with a reference value to generate current control data. For example, the processor 21 generates current control data of 0 when the difference value D (absolute value) is smaller than a first reference value K1 (0≦D<K1), and generates current control data of 1 when the difference value D is greater than or equal to the first reference value K1 and smaller than a second reference value (K1≦D<K2). Further, the processor 21 generates current control data of 2 when the difference value D is greater than or equal to the second reference value K2 and smaller than a third reference value K3 (K2≦D<K3), and generates current control data of 3 when the difference value D is greater than or equal to the third reference value K3 (K3≦D).

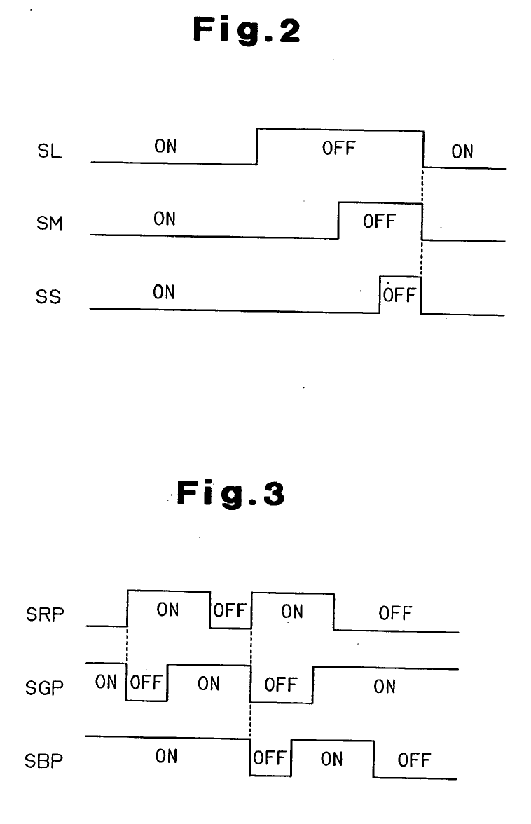

The pulse width modulation circuit 24 generates a current control signal CC based on the current control data. In the preferred embodiment, the pulse width modulation circuit 24 generates three current control signals SS, SM, and SL as the current control signal CC and shifts the level of each of the current control signals SS, SM, and SL based on the current control data in the manner shown in FIG. 2. For example, the pulse width modulation circuit 24 outputs high (H) level current control signals SS, SM, and SL based on the current control data of 0, and outputs a low (L) level current control signal SS and a H level current control signals SM and SL based on the current control data of 1. Further, the pulse width modulation circuit 24 outputs L level current control signals SS and SM and a H level current control signal SL based on the current control data of 2, and outputs L level current control signals SS, SM, and SL based on the current control data of 3.

The processor 21 may calculate the total of the brightness values of the video data to generate the current control data by comparing the calculation result with a reference value. A circuit other than the pulse width modulation circuit 24 (e.g., the processor 21) may generate the current control signal. The processor 21 may use an average value (or an integration value or a derivative value) of average values (total values) calculated for a plurality of frames as a determination value to generate current control data based on the determination value and a reference value. Moreover, the processor 21 may further use, in the determination, a maximum value or a minimum value of the brightness values of video data corresponding to one frame.

As shown in FIG. 1, the display module 12 includes a display unit (display region) 31, a current drive circuit 32, a horizontal drive circuit 33, a vertical drive circuit 34, and a precharge circuit 35. The display unit 31 includes a matrix of cells GS. FIG. 1 shows only one cell GS. The horizontal drive circuit 33 operates in response to an H-pulse (horizontal scan pulse) signal that is provided from the video signal processing unit 11. The vertical drive circuit 34 operates in response to a V-pulse (vertical scan pulse) signal. This sequentially selects the cells GS included in the display unit 31. The current drive circuit 32 provides a drive current to a selected cell GS in accordance with the current control signal CC and the RGB pulse width modulation signals. The precharge circuit 35 precharges the drain line to which the cell GS is connected in response to a signal Preset provided from the video signal processing unit 11.

As shown in FIG. 4, the current drive circuit 32 includes a current amount control circuit 41 and a drive current generation circuit 42. The current amount control circuit 41 controls the amount of current supplied from a high potential power supply Vcc to a transmission line (transmission path) 51 in response to the current control signal CC (current control signals SS, SM, and SL). Based on the RGB pulse width modulation signals, the drive current generation circuit 42 controls the amount of current flowing through the transmission line 51 in accordance with the gray scale value of each pixel. Current, which corresponds to the difference between the current controlled by the current amount control circuit 41 and the current controlled by the drive current generation circuit 42, flows through the transmission line 51. The drive current generated by the drive current generation circuit 42 is used as a base current, and the current amount control circuit 41 adds a current amount to the drive current. In other words, the current amount control circuit 41 weights the drive current using the current control signal CC.

The pulse width modulation signals include the pulse width modulation signal SRP corresponding to red (R), the pulse width modulation signal SGP corresponding to green (G), and the pulse width modulation signal SBP corresponding to blue (B). To facilitate description, the circuit section associated with only the pulse width modulation signal SRP will be described. Circuits identical to the circuits associated with the pulse width modulation signal SRP are used for the processing of the pulse width modulation signals SGP and SBP.

The current amount control circuit 41 includes a plurality of (three in the preferred embodiment) P-channel MOS transistors M1, M2, and M3, which are connected in parallel between a high potential power supply Vcc and the transmission line 51. The transistors M1 to M3 are respectively turned on and off in response to the current control signals SS, SM, and SL, which are provided to their gates. Current I1, which is in accordance with the number of transistors that are turned on based on the current control signals SS, SM, and SL, is supplied from the high potential power supply Vcc to the transmission line 51.

The drive current generation circuit 42 includes an N-channel MOS transistor M4, which is connected between the transmission line 51 and a low potential power supply (ground GND in the preferred embodiment). The transistor M4 is turned on and off in response to the pulse width modulation signal SRP provided to its gate. The transistor M4 remains on or off for a period corresponding to the pulse width of the pulse width modulation signal SRP.

A drain of P-channel MOS transistor M5 is connected to a transfer gate TG. The transistor M5 has a source supplied with power supply voltage Vcc and a gate connected to the gate of a transistor M6. The transistor M6 stabilizes the drive current supplied to each cell GS and functions to stabilize the luminous brightness of each cell GS. The transistor M5 is turned on in response to the pulse of the transistor M4 to supply drive current to each cell GS. The transistor M5 and M6 forms a current mirror circuit.

The transfer gate TG supplies the current I1, which flows through the transistor M5, to the drain line 61 in response to switching signals SW and *SW (*SW is obtained by inverting SW). The switching signals SW and *SW are horizontal scan signals provided from the horizontal drive circuit 33 shown in FIG. 1.

Each cell GS included in the display unit 31 of the display panel is arranged in the vicinity of an intersection of the drain line 61 and a gate line 62. The cell GS includes a pixel selection TFT 71 and a current drive type light emitting element L1, which functions as a current drive element (e.g., an LED element, an organic EL (electroluminescent) element, or an inorganic EL element). The gate line 62 is connected to the gate of the pixel selection TFT 71. The vertical drive circuit 34 shown in FIG. 1 provides a vertical scan signal to the gate line 62. The pixel selection TFT 71 provides the drive current I1 from the drain line 61 to the current drive type light emitting element L1 in response to the vertical scan signal.

The operation of the display module 12 will now be described.

The level of each of the current control signals SS, SM, and SL is set in accordance with the brightness of the original video data SR. The pulse width of the pulse width modulation signal SRP changes in accordance with the size of the original video data SR.

In one example, the current control signals SS, SM, and SL are set at an H level (that is, the current control data is 0) in accordance with the brightness of the video data SR. In this example, the transistors M1 to M3 are turned off. The transfer gate TG is turned on in response to the switching signals SW and *SW. During a period in which the transfer gate TG remains on, the transistor M4 is turned on in response to the pulse width modulation signal SRP. A pulse that is in accordance with the pulse width of the pulse width modulation signal SRP is generated in the transistor M4. The transistor M5 is turned on in accordance with the pulse of the transistor M4. The current flowing through the transistor M5 is supplied to the cell GS via the transfer gate TG. As a result, current proportional to the pulse period of the pulse width modulation signal SRP (period in which the signal is maintained at an H level in the preferred embodiment) is supplied to the light emitting element L1 of the cell GS. The light emitting element L1 generates light with an intensity that is in accordance with the current supplied to the light emitting element L1.

In another example, the current control signal SS is set at an L level (that is, the current control data is 1) and the current control signals SM and SL are set at an H level in accordance with the brightness of the video data SR. In this example, the transistor M1 is turned on and the transistors M2 and M3 are turned off. Accordingly, current flows through the transmission line 51 via the transistors M1 and M6, and current mirror current, which is the same as current flowing through transistors M1 and M6, flows through the transistor M5. In other words, more current flows through the transmission line 51, i.e., the transistor M5 compared to the above example. The control signal SS causes the current amount control circuit 41 to function as a current adding circuit for performing current weighting or adding on the drive current that flows in response to the pulse width modulation signal SRP in accordance with the brightness state of video data corresponding to one frame. Current proportional to the pulse period of the pulse width modulation signal SRP is supplied to the light emitting element L1 of the cell GS. The light emitting element L1 generates light with an intensity that is in accordance with the current supplied to the light emitting element L1. In this state, the amount of current flowing through the transmission line 51 is greater than that in the above example. The light emitting element L1 generates light at an intensity that is greater than that in the example described above.

The current control signals SS, SM, and SL are set for each frame. Thus, current greater than the drive current supplied when only the transistor M5 is turned on flows through all the cells GS of the display unit 31. The amount of drive current supplied to a cell is proportional to the brightness of the cell. This increases the brightness difference between cells GS, that is, increases the contrast ratio. In detail, when, for example, the display image is entirely bright and drive current is supplied to cell GS to generate relatively dark light in accordance with the video data, the difference between the drive current supplied when only the transistor M5 is turned on and the drive current supplied when the transistors M5 and M3 are turned on is assumed to be ΔI1. When the display image is entirely bright and drive current is supplied to a cell GS to generate relatively bright light in accordance with the video data, the difference between the drive current supplied when only the transistor M5 is turned on and the drive current supplied when the transistors M5 and M3 are turned on is assumed to be ΔI2. The amount of drive current provided to a cell is proportional to the brightness of the cell. Thus, the current difference ΔI2 is greater than the current difference ΔI1 (ΔI1<ΔI2). This increases, for example, the difference in brightness between the relatively dark cell and the relatively bright cell in the entirely bright image, that is, the contrast ratio. The same applies to each one of the cells GS forming one frame. As a result, a person is able to more easily perceive the difference in brightness between cells GS included in the image corresponding to one frame.

In the same manner as described above, the current control signals SM and SL enable the amount of drive current provided to each cell GS to be controlled in proportion to the brightness of the cell. As a result, a person is able to clearly perceive the difference in brightness between cells GS included in an image corresponding to one frame. This increases the contrast ratio of the entire video and obtains a sharp image.

The video data display system 10 of the preferred embodiment has the advantages described below.

The current drive circuit 32 includes the current amount control circuit 41 and the drive current generation circuit 42. The current amount control circuit 41 controls the amount of current supplied from the high potential power supply Vcc to the transmission line (transmission path) 51 in response to the current control signal CC. The drive current generation circuit 42 controls the amount of current flowing through the transmission line 51 in accordance with the gray scale value of each pixel in response to the RGB pulse width modulation signals. Current corresponding to the difference between the current controlled by the current amount control circuit 41 and the current controlled by the drive current generation circuit 42 flows through the transmission line 51. Thus, when the drive current generated by the drive current generation circuit 42 is used as a base current, the current amount control circuit 41 adds a current amount to the drive current. In other words, the current amount control circuit 41 weights the drive current with the current drive signal CC. The weighting causes a difference in brightness between two cells GS as described above and increases the contrast ratio. The same applies to all the cells GS included in one frame. As a result, a person is able to more clearly perceive the difference in brightness between cells GS.

It should be apparent to those skilled in the art that the present invention may be embodied in many other specific forms without departing from the spirit or scope of the invention. Particularly, it should be understood that the present invention may be embodied in the following forms.

The transistors M5 and M6 connected to the transmission line 51 supply each cell GS with drive current for normal images (such as an image with a high contrast that is easily perceived and an image of which determination value is set close to an intermediate value of the number of gray scale levels). The transistors M5 and M6 enable the display characteristic of each cell GS to be as uniform as possible or enable the supply of stable current to each cell GS. Although the transistors M5 and M6 are advantageous in this respect, the transistors M5 and M6 may be omitted. In this case, the transistors M1 to M3 in the current amount control circuit 41 may be used to supply drive current to each cell GS.

The configuration of the current drive circuit 32 may be changed if necessary.

The present invention may be applied to other display modules (display devices) having current drive elements, such as an organic light emitting diode (OLED) device, an LED matrix display device, or a liquid crystal display (LCD) device having a current drive element (e.g., TFD).

The present examples and embodiments are to be considered as illustrative and not restrictive, and the invention is not to be limited to the details given herein, but may be modified within the scope and equivalence of the appended claims.

What is claimed is:

1. A display module for displaying an image in accordance with video data including brightness and a gray scale value, the display module comprising:
a plurality of current drive elements operated by a drive current; and
a current drive circuit for generating the drive current in accordance with the gray scale value of the video data and the brightness of the video data.

2. The display module according to claim 1, wherein the current drive circuit includes:
a drive current generation circuit for generating the drive current in accordance with the gray scale value of the video data; and
a current adding circuit, connected to the drive current generation circuit, for adding current to the drive current in accordance with the brightness of the video data for one frame.

3. The display module according to claim 2, wherein the drive current generation circuit receives a pulse width modulation signal, which has a pulse width that is in accordance with the gray scale value of the video data, and generates the drive current in response to the pulse width modulation signal; and
wherein the current adding circuit receives a current control signal, which is in accordance with the brightness of the video data for one frame, and adds the current to the drive current in response to the current control signal.

4. The display module according to claim 3, wherein a number of gray scales is set for the display module, and the current control signal corresponds to difference between a determination value, which is based on the brightness of the video data, and an intermediate value of the number of gray scales of the display module.

5. The display module according to claim 4, wherein the determination value is an average value of the brightness of the video data for one frame.

6. A display module for displaying an image in units of single frames in accordance with video data including brightness and a gray scale value, the display module comprising:
a drive current generation circuit for generating drive current in accordance with the gray scale value of the video data;
a current adding circuit, connected to the drive current generation circuit, for adding current to the drive current in accordance with the brightness of the video data for one frame; and
a current drive element operated by the drive current.

7. The display module according to claim 6, wherein the drive current generation circuit receives a pulse width modulation signal, which has a pulse width that is in accordance with the gray scale value of the video data, and generates a drive current in response to the pulse width modulation signal; and
wherein the current adding circuit receives a current control signal, which is in accordance with the brightness of the video data for one frame, and adds current to the drive current in response to the current control signal.

8. The display module according to claim 7, wherein a number of gray scales is set for the display module, and the current control signal corresponds to difference between a determination value, which is based on the brightness of the video data, and an intermediate value of the number of gray scales of the display module.

9. The display module according to claim 8, wherein the determination value is an average value of the brightness of the video data for one frame.

10. A display module for displaying an image in units of single frames in accordance with video data including brightness and a gray scale value, the display module comprising:
a transmission path;
a current amount control circuit, connected to the transmission path and a high potential power supply, for controlling the amount of current supplied from the high potential power supply to the transmission path in accordance with the brightness of the video data for one frame;
a drive current generation circuit, connected to the transmission path, for generating drive current in accordance with the gray scale value of the video data based on the current flowing through the transmission path; and
a current drive element operated by the drive current.

11. The display module according to claim 10, wherein the current amount control circuit receives a current control signal, which is in accordance with the brightness value of the video data for one frame, and controls the amount of current supplied from the high potential power supply to the transmission path in response to the current control signal; and
wherein the drive current generation circuit receives a pulse width modulation signal, which is in accordance with the gray scale value of the video data, and generates the drive current in response to the pulse width modulation signal.

12. The display module according to claim 11, wherein a number of gray scales is set for the display module, and the current control signal corresponds to difference between a determination value, which is based on the brightness of the video data, and an intermediate value of the number of gray scales of the display module.

13. The display module according to claim 12, wherein the determination value is an average value of the brightness of the video data for one frame.
